(19) United States
(12) Patent Application Publication
(10) Pub. No.: US 2023/0404022 A1
(43) Pub. Date: Dec. 21, 2023

(54) DEVICE AND SYSTEM FOR CONTROLLED MIXING OF FLUID TEXTURED MATERIAL ALONG A LINEAR PATH BY MEANS OF VARIABLE OHMIC CONTROL

(71) Applicant: Daniel R. LINDGREN, Reedsville, WI (US)

(72) Inventor: Daniel R. LINDGREN, Reedsville, WI (US)

(73) Assignee: Creative Design & Engineering, LLC, Reedsville, WI (US)

(21) Appl. No.: 18/124,869

(22) Filed: Mar. 22, 2023

Related U.S. Application Data
(60) Provisional application No. 63/354,222, filed on Jun. 21, 2022.

(51) Int. Cl. A01J 25/00; B29B 7/40; B29C 48/40; B29C 48/68; B29C 48/80

(52) U.S. Cl. CPC A01J 25/008; B29B 7/40; B29C 48/40; B29C 48/6801; B29C 48/832; A23V 2002/00; A23C 19/08

(57) ABSTRACT

The invention herein pertains to a device and system for controlled mixing of textured material along a linear path by means variable ohmic controls. The device comprising the following components: a dual auger unit wherein two linear augers are held within a single linear casing, each said linear augers having an increased diameter pitch along its length, perforations along the length of said single linear casing, electro-conductive plates attachable to each said perforation. The preferred embodiment of this invention is intended to be used for mixing pasta filata cheese curds to form a singular cheese mass with consistent texture. The device may also be used to mix other types of fluid textured material including food and non-food substances.

### CROSS-REFERENCE TO RELATED APPLICATIONS

This application is a non-provisional patent application claiming benefit of priority of the previously filed and pending provisional patent application, Patent App. No. 63/354,222, filed on Jun. 21, 2022, in accordance with 35 U.S.C. 120 and 35 U.S.C. 119(e).

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark office, patent file or records, but otherwise reserves all copyright rights whatsoever.

### BACKGROUND OF INVENTION

### Field of the Invention

The present inventive subject matter relates to a device and system for ohmic heating and mixing by variable conductive heating controls.

### Background

The industry for manufacturing pasta filata cheese has been incorporating ohmic heating technology over liquid brine heating methods as an alternative means for manufacturing cheese in hopes to improve sanitation, economy, and efficiency. However, the implementation of ohmic technology has been not without challenge. The inconsistent nature of nascent cheese curds in a cool state is difficult to heat consistently. Each curd is shaped differently with different networks of protein construct, moisture, salt levels, and density. Variations in these qualities affect their inherent electroconductivity. Electricity will pass through the cross-section of each curd at different rates, along different paths, causing variations of heat concentrations within each cheese curds. This can lead to uneven heating of each cheese curd and of the entire batch of curds contained together within each heating session. The current means or tools for administering ohmic heat is by electrical probes, plates, or augers. As the curds are mixed during ohmic treatment, they begin to combine their protein structures which continuously break and form into a braided or networked matrix of elongated strands. This means that the electroconductivity of the nascent cheese mass will change very rapidly and inconsistently at the early stage of blending curds together. The heat created by the passage of electricity through the cheese mass may wildly shift depending on the rate of mixing and how the cheese is behaving in any given batch. A premature and disproportionate amount of settling may occur in the cheese mass of any given batch where a denser patch within the cheese mass is formed and remain unchanged for a longer period of time. This may lead to disproportionate density within the cheese mass and thus uneven levels of electro-conductivity therein. This can cause uneven heating and potentially overheating of a certain portion of the cheese. The end effect may lead to uneven texture and flavor of the final cheese product.

U.S. Pat. No. 5,758,015A relates to a method and device that ohmically heats and pasteurizes uncooked liquid eggs. Patent '015 addresses a manner of controlling temperature along a linear flow path where areas of conduction are segmented off into separate zones, each zone having its own separate electrical output. This invention recognizes the difficulty of having a single point of conduction along the entire path of flow without causing uneven heating and unwanted impact on the food product at different locations of said path. Patent No. '015 does not teach a method for adjusting temperature within each zone.

Patent application U.S. Ser. No. 16/948,642 provides several alternative methods for administering heat by steam, infrared, convection, induction, microwave, ohmic, microwave, radio frequency, and combinations thereof. While the application references use of ohmic heating methods, it suggests only use of electrodes as a tool or device for administering electricity.

Similarly, U.S. Pat. No. 9,924,729 by the same inventor herein, provides for an improved method of manufacturing pasta filata cheese by ohmic heating methods. However, Patent No. '729 discloses the use of a plate, probe, or auger as a means or tool for administering ohmic heat. Patent No. '729 does not address the problems and issues raised herein and thus does not contemplate an improved method, system, or device for administering ohmic heat.

There remains a need in the art for a device and system of administering electricity and ohmically heating food material, specifically pasta filata cheese, in a manner that allows for control over the consistency of heat within the cheese mass as its structure physically and chemically changes during the heating process. The prior art technology relating to electro-conductive heating falls short of an effective method and device that solves the problems identified herein.

### BRIEF SUMMARY OF INVENTION

The invention herein relates to a device and system for controlled cooking and mixing of fluid textured material along a linear path by means of variable ohmic control. Specifically, a means for cooking and mixing pasta filata cheese curds to form a cheese mass with consistent texture throughout. The device may also be used to mix other types of fluid textured material including food and non-food substances. The unique variable ohmic control of this invention aids to maintain a preferred temperature along a linear path by adjusting ohmic output at various locations (or zones) along said linear path as the level of resistance in the cheese mass changes while it traverses through said linear path. The ohmic output is adjustable at certain cross-sectional zones along said linear path by manner of controlling the network of paths or vector flow of electricity, the intersection of multiple paths or vectors of electrical flow, and the frequency pattern of output (pulsation rate) within and between each zone. The nascent cheese particles (curds) enter into a linear co-rotating auger system at a proximal end and passes through said auger system towards a distal end. The level of conductivity of the cheese improves with improved consistency of the internal protein structure and distribution in the cheese texture along this path.

An additional inventive aspect of this invention provides for an increasing pitch to each auger diameter of two co-rotating augers from the proximal end to the distal end. As such, the density of the cheese mass begins in less dense form and further increases as it moves from a more spacious mixing zone at the proximal end to a tighter mixing zone towards the distal end. The levels of conductivity will improve from proximal to distal end as the cheese becomes more thoroughly mixed and evenly textured with improved density. This helps to control the rate and degree of voltage transfer and minimize an arcing effect based on the capability of the cheese mass to conduct electricity according to its internal structure. The result, in this case, would be a slower rate of warming of the cheese at the proximal zone to avoid burning, a gradual increase of heat in the middle zone as texture improves, and a hastened increase and heating of the cheese at the distal zone to speed up the mixing and pasteurization process. By this invention, a consistent texture, flavor, and mixing speed are achievable.

This invention teaches a preferred embodiment of a device comprising: a single linear casing having an open proximal end and an open distal end, two linear augers adjacently positioned in parallel manner forming a dual auger unit, said dual auger unit contained within said single linear casing, each auger of said dual auger unit having a gradual increase in diameter pitch along its length, each said auger of said dual auger unit having a narrower diameter at the proximal end of said single linear casing and a wider diameter at the distal end of said single linear casing, said linear casing having at least one set of perforation therethrough, each set of perforation comprising two perforations, each perforation of each set of perforation is disposed 180 degrees away from the other around the cross-sectional perimeter of said single linear casing each perforation of each set of perforation is detachably connectable to a plate of the same dimension and shape as the dimension and shape of each said perforation said plate is either electro-conductive or non-electro-conductive, said electro-conductive plate is removably attachable to an electrical source to create either a positive or negative charge, each set of perforation detachably connected to one positively and one negatively charged electro-conductive plate, a plurality of sets of perforations located around a cross-sectional section of said single linear casing, said plurality of sets of perforations comprising more than one set of perforation, each said set of perforation of said plurality of sets of perforations being equal distant from another set of perforation around the cross-sectional perimeter section of said single linear casing, the amount, rate, and frequency of electricity that passes through each said plate held within each set of perforation is adjustable.

The invention further teaches a preferred embodiment of a system comprising the device as described herein, wherein said single linear casing having a plurality of sets of perforations located at three cross-sectional locations along its length, each cross-sectional location along the length of said single linear path comprising a zone of electro-conduction, said single linear casing having a first electro-conductive zone, a second electro-conductive zone, and a third electro-conductive zone located equal distant from each other along the length of said single linear casing, the amount, rate, and frequency of electricity that passes through each said plate held within each set of perforation is adjustable within each electro-conductive zone and between each electro-conductive zone.

Other features, advantages, and object of the present invention will become more apparent and be more readily understood from the following detailed description, which should be read in conjunction with the accompanying drawings.

### BRIEF DESCRIPTION OF FIGURES

FIG. 1 provides a drawing and description of an embodiment of the inventive device and system as described herein.

FIG. 2 provides a drawing and description of an embodiment of the inventive device and system as described herein.

FIG. 3 provides a drawing and description of an embodiment of the inventive device and system as described herein.

FIG. 4 provides a drawing and description of an embodiment of the inventive device and system as described herein.

### DETAILED SUMMARY OF INVENTION

The present invention is best understood by reference to the detailed figures and description set forth herein. Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Embodiments of the invention are discussed herein with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be understood that any exact measurements, dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

The invention herein pertains to a device and system for a controlled manner of mixing of textured material (i.e. pasta filata cheese, other edible and non-edible fluid textured material, etc.) along a linear path by ohmic means and variable ohmic controls. The device comprises the following components: a) two linear auger elements positioned adjacently in side by side parallel manner comprising a dual auger unit, b) said dual auger unit contained within a single linear casing, comprising a mixing unit, c) said single mixing unit having a proximal and distal end, a left and right side, a top and bottom side, d) said single linear casing optionally having perforations therethrough at its top, bottom, left, or right sides or a combination of sides, e) said single linear casing optionally having shelve locations at pre-defined locations within it internal surface where electro-conductive plates may be attached, f) said single linear casing being open at its proximal and distal ends for receiving and releasing said textured material, g) a hopper element disposed at the proximal end of said single mixing unit that is used to contain and dispense pre-mixed textured material thereinto. The preferred embodiment of this invention is intended to be used for mixing pasta filata cheese curds to form a singular cheese mass with consistent texture. However, the device may also be used to mix other types of textured material including food and non-food substances.

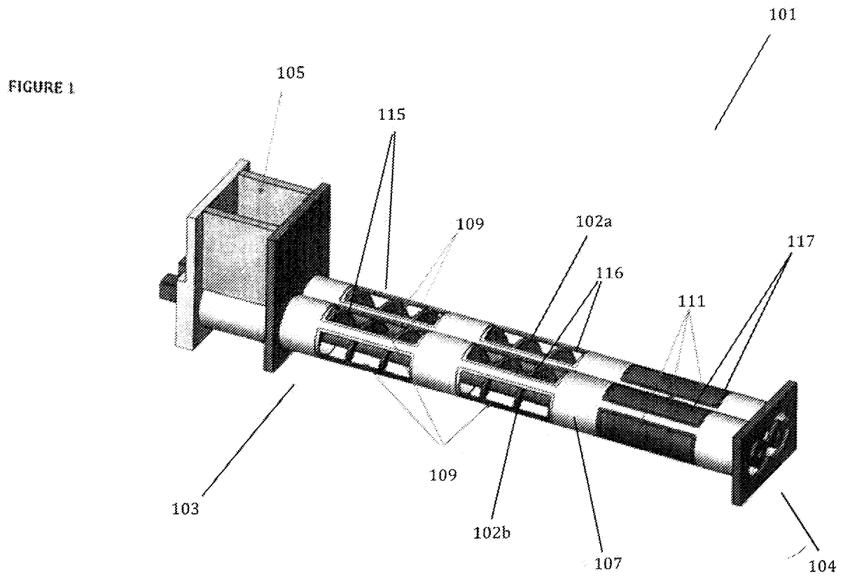

A preferred embodiment of the device is presented in the illustrations provided herein according to FIGS. 1 through 3. According to FIG. 1, a dual auger unit 101 is provided that comprises two linear rotatable augers 102a,b positioned immediately adjacent to each other in parallel manner. Each said linear rotatable auger 102a,b is rotatable along a central shaft and disposed along a linear path. The terminal ends of each said linear rotatable auger forms either the proximal 103 or distal 104 ends of said dual auger unit 101 and the device 100 itself. A hopper element 105 is disposed at the proximal end 103 of said device. Said hopper element 105 comprising a container that is adjacently positioned next to the proximal end 103 of the dual auger system 101 wherein material contained within the container may be fed into the proximal end 103 of said dual auger system 101. Said hopper element 105 may be positioned at any location adjacent to the proximal end 103 of said dual auger unit 101 so long as said material may be released from said hopper container and dispensed into the proximal end 103 of said dual auger unit 101 to be engaged by said two linear rotatable augers 102a,b. Each said linear rotatable auger 102a,b of said two linear rotatable augers 102a,b may be co-rotating or counter-rotating relative to each other, depending on the degree of sheer effect or the level of mixing desired. Co-rotation refers to the rotational path of two adjacently disposed linear augers, each moving in the same circular direction of the other tandemly in a clock-wise fashion or counter-clockwise fashion around their each central axis. For purposes of this invention, the two linear rotatable augers preferably co-rotates relative to each other when used to prepare pasta filata cheese.

Each linear rotatable auger 102a,b of said dual auger unit 101 is positioned in parallel to each other without direct contact with each other. Each linear rotatable auger 102a,b is slightly offset from the other, both of which are rotatable around their own central axis without contacting the other during rotational spin. Said dual auger unit 101 is centrally positioned within a single linear casing 107 that is hollow internally. Said single linear casing is intended to contain and pass along material to be engaged for mixing. The preferred embodiment of this invention would utilize a co-rotating dual linear auger unit 101 to mix pasta filata cheese curds to produce a cheese mass with consistent texture. Said material is further moved forward along the linear path of said co-rotating dual auger unit towards its said distal end.

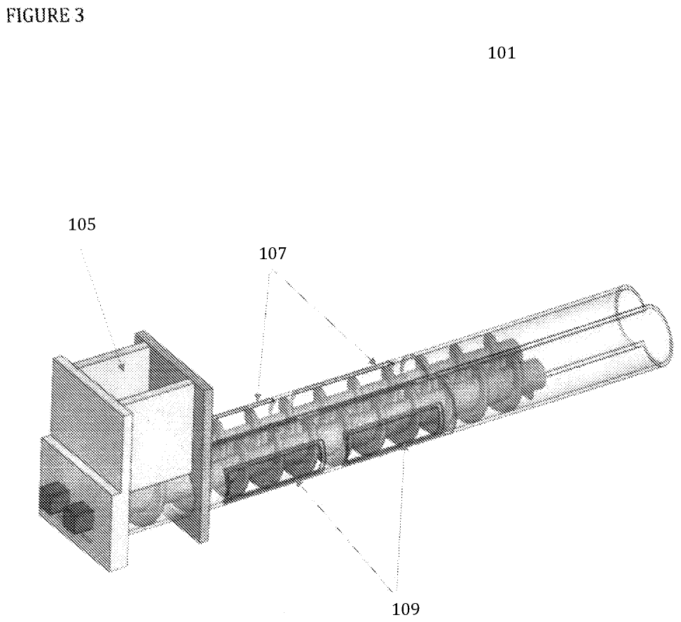

As shown in FIGS. 1 and 3, said single linear casing 107 may comprise a single cylinder with one or more curved or angled features 108 or a combination of curved and angled features, that molds said single cylinder 107 around the outer perimeter of said dual auger unit 101 while containing said two linear auger elements 102a,b within without sectioning either augers off from each other. Said single linear casing 107 comprising a durable hard shell made of inert, non-electro-conductive, food-grade material. Said single linear casing 107 preferably does not directly contact either of said two linear rotatable augers 102a,b. The single linear casing 107 and each linear rotatable auger 102a,b are each made of non-electro-conductive material.

According to a preferred embodiment of this invention, the surface of said single linear casing 107 having one or more perforations 109 therethrough. According to a preferred embodiment as shown in FIGS. 1 and 3, the perforations 109 comprises oppositely disposed pairs of perforation 110 wherein each of said oppositely disposed pair 110 is positioned 180 degree of the other around the cross-sectional perimeter of said single linear casing 107. Each said perforation 109 of said oppositely disposed pairs of perforation 110 penetrating through the surface of said single linear casing 107 such that an open window space is created for access and viewing between its internal and external environment. Each perforation 109 of said oppositely disposed pairs of perforation 110 having a preferred dimensional-sized surface area. According to a preferred embodiment of this invention, three sets of oppositely disposed pairs of perforations are positioned around the perimeter surface of said single linear casing 107. Each set is evenly-spaced from the other around the cross-sectional perimeter of said single linear casing.

Further as shown in FIG. 1, an electrode plate 111 is attachable and held within each said perforation 109 of said single linear casing, covering the entire open area of each said perforation. The electrically charged path of each said electrode plate 111 travels between two oppositely disposed pairs of perforation 110 from a positively to negatively charged electrode plate along a linear path. Said device further containing a grounding element. Each perforation 109 of said oppositely disposed pairs of perforation 110 may also be attached to and covered by a neutral plate that functions as a non-electro-conductive insulating cover. Said neutral plate covers any of each said perforation, allowing the material undergoing mixing to pass through the hollow internal cavity of said single linear casing insulated from the external environment. Each said neutral element and each said electrode plate are interchangeably attachable to each said perforation.

Each electrode plate 111 is electro-conductive in nature, capable of sending and receiving an electric charge from positive to negative position. Each said electrode plate 111 is removably attachable to a source of electricity whereby an electrical charge may be turned on or off and conducted between positively charged to negatively charged electrode plates (also referable as “pair of plates”) of each said oppositely disposed pairs of perforation. The conduction of electricity between each said pair of plates creates a linear electrical pathway between across the cross-section of said device. The dimensional size of each said linear electrical pathway creates an electrical field that is equivalent to the dimensional size and area of their each respective electro-conductive plate 109 of said pair of plate. The material passing through said single linear casing, being electro-conductive in nature, serves as an electrical conduit between the positive and negatively charged plates of each said pair of plates. When a pair of plates are charged, electricity passes through the electrical pathway, warming up the conductive material (i.e. cheese) passing through that path.

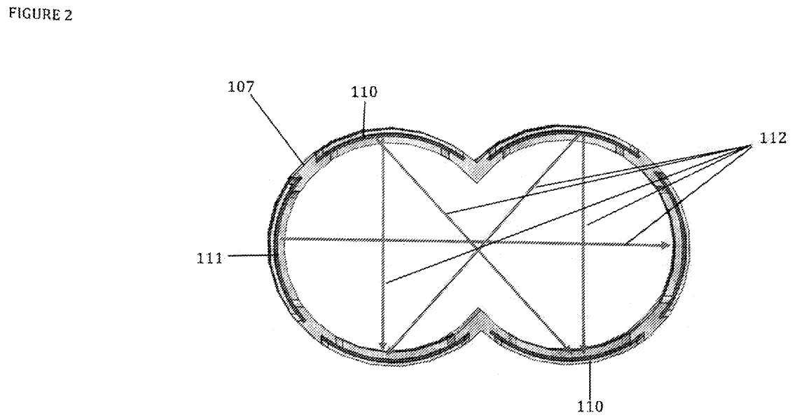

The position and quantities of oppositely disposed pairs of perforation 110 and their respective pairs of plates on any given device of this invention define a network pattern of electrical pathways 112 that crisscrosses the cross-section of the device. The network pattern of electrical pathways 112, as shown in FIG. 2, helps to spread electrical conduction evenly throughout the cross-section of the material held within said single linear casing.

Conduction of electricity among any given pair of plates may be either continuous or pulsating (turned on and off at a defined frequency and speed) in nature. Said pattern of pulsation may be staggered between each pair of plates to create a three-phase electrical conduction effect within the cross-sectional space of said single linear casing for more even conductive heating. The pattern of electro-conduction that is created by a given pattern of disposition of the electrode plates defines the heating pattern of a given section of the device along its length 112. Multiple sections with different electro-conduction patterns and different patterns of electrode plate disposition may exist along the length of a given device for variable control of heating along its linear path. Each section is herein referenced interchangeably as a phase of heating along the length of the device.

The preferred embodiment of the invention as described above enables localized control of ohmic heating at different segmented locations (sections) along the length of said single linear casing. Alternatively, the pattern of electrical pulsation may further be staggered between sections along the length of said single linear casing to create a three-phase conductive effect along the length of said device. This helps to evenly disburse electro-conduction evenly along the entire length and internal cross-section of said single linear casing. The degree and spatial coverage of administered electro-conduction and heat are controllable by managing and adjusting the pattern of electrical network 112 within the internal cross-section of said device, along the length of said device, and by the pattern of pulsation between any given pair of plates. These features may be adjusted manually, automatically, or according to preconfigured settings in response to the ever-changing level of conductivity and amplitude residence from the material passing through.

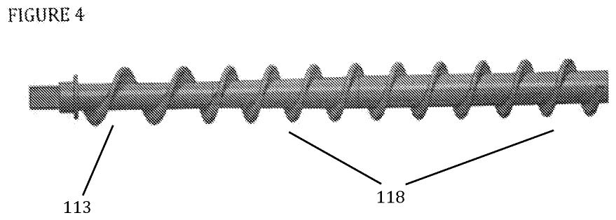

According to another embodiment of this invention as shown in FIG. 4, each auger of said co-rotating dual augers having a gradual increase in diameter along its length from said proximal to said distal end of said device. The diameter of each linear auger is more narrow at the proximal end of said device 113 and broader or wider at the distal end of said device 114. The increase in diameter will have an effect of increasing compression on the cheese mass that is passed through from said proximal end towards said distal end. This would compact the cheese mass, increasing its density while its texture becomes more even as it is continuously mixed.

The aim of this invention is to create a system by which nascent cheese curd is captured at the proximal end of said device and mixed to a heated and even texture towards the distal end at a quicker pace through means of controlling ohmic heat. The level of compression at the proximal end is lower due to the narrower diameter of each auger 113 (as shown in FIG. 4) and wider space between said dual augers. This location, as shown in FIG. 3, may be identified as the “Feed Zone” (referred to interchangeably as Zone 1) 115 of the device where the nascent cheese curd enters the proximal end and begins integration. Conductivity of the cheese at this section is low due to lower and uneven density of the material at this location. This translates to an overall higher level of electrical resistance and therefore, the cheese within Zone 1 115 may not be able to receive a high level of charge without an arcing effect which causes burning. The cheese material within Zone 1 115 is typically a poorer electrical conduit. Given this challenge, a set of perforation and plates are positioned at the Feed Zone 115 where the amplitude of conducted electricity is managed at a lower frequency with the aim of warming and melting the cheese without burning it.

As the cheese is warmed and mixed, moving forward towards a more compressed area between the augers (greater auger diameter 118), the cheese material will be more consistent in texture, improving its conductivity. This second area, as shown in FIG. 3, may define the second section of the device, also referable to as the “Compression Zone” (referable as Zone 2) 116. As the cheese texture becomes more consistent and denser within Zone 2 116, amplitude resistance lowers and conductivity improves evenly throughout. Electrical input may be increased with a lower risk of burning within the Compression Zone 116.

Once the cheese mass reaches a certain level consistent texture, the temperature of the cheese may be maintained at a higher level to allow the finishing of the mixing process for the desired texture quality. This section of the device, as shown in FIG. 3, is identified as the “Mixing Zone” (referable also as Zone 3) 117. Conductivity of the cheese mass is highest within Zone 3 117 with the lowest level of resistance here, which helps to hasten the mixing process. By controlling heat conduction in this variable, progressive, and segmented manner, the mixing process is hastened in a consistent manner for a consistently repeatable high-quality product.

The coordination of electricity (measurable in Voltage or Amplitude) input or output through any given pair of plates at a given location along the length of said device may be manually adjustable, automatically adjustable, or preconfigured for a set level and duration. A temperature probe may be disposed within the single linear casing to read the temperature of the material passing through at any location. Communication of said temperature probe may be relayed to a computer software system. Said computer software program is preconfigured to analyze the data received from said temperature probe and determine a desired amplitude or voltage input or output to achieve a certain level of temperature adjustment at that said location. This system of adjustment may be achieved manually or automatically. The goal of this system is to achieve a consistently heated and consistently textured cheese mass by manner of electro-conduction at adjustable levels of electro-conduction and speed without compromising quality of flavor or texture.

What is claimed is:

1. A device comprising
a single linear casing having an open proximal end and an open distal end,
two linear augers positioned in parallel manner forming a dual auger unit,
said dual auger unit contained within said single linear casing,
each auger of said dual auger unit having a gradual increase in diameter pitch along its length,
each said auger of said dual auger unit having a narrower diameter at the proximal end of said single linear casing and a wider diameter at the distal end of said single linear casing,
said linear casing having at least one set of perforations therethrough,
each set of perforation comprising two perforations,
each perforation of each set of perforations is disposed 180 degrees away from the other perforation of said set of perforations around the cross-sectional perimeter of said single linear casing,
each perforation of each set of perforations is detachably connectable to a plate,
said plate is either electro-conductive or non-electro-conductive.

2. A system comprising
a device according to claim 1,
said single linear casing having a plurality of sets of perforations located at three cross-sectional locations along its length,
each cross-sectional location along the length of said single linear path comprising a zone of electro-conduction,
said single linear casing having a first electro-conductive zone, a second electro-conductive zone, and a third electro-conductive zone located along the length of said single linear casing,
the level rate, and frequency of electricity that passes through each said plate is adjustable within each electro-conductive zone and between each electro-conductive zone.

3. Said device according to claim 1 wherein said electro-conductive plate is removably attachable to an electrical source to create either a positive or negative charge.

4. Said device according to claim 3 wherein each set of perforations detachably connected to one positively and one negatively charged electro-conductive plate.

5. Said device according to claim 3 wherein the level, rate, and frequency of electricity that passes through each said plate is adjustable.

6. Said device according to claim 1 comprising a plurality of sets of perforations located around a cross-sectional section of said single linear casing.

7. A device according to claim 6 wherein each said set of perforation of said plurality of sets of perforations is equal distant from another set of perforations around the cross-sectional perimeter section of said single linear casing.
